(19) United States
(12) Patent Application Publication
(10) Pub. No.: US 2014/0146526 A1
(43) Pub. Date: May 29, 2014

(54) MOBILE BEACH STORAGE POLE

(71) Applicants: Lee S. Evans, SR., Canton, GA (US); Timothy D. Jones, Kennesaw, GA (US)

(72) Inventors: Lee S. Evans, SR., Canton, GA (US); Timothy D. Jones, Kennesaw, GA (US)

(21) Appl. No.: 13/689,322

(22) Filed: Nov. 29, 2012

(51) Int. Cl. F16M 11/00; F21L 4/00; H02J 7/35

(52) U.S. Cl. CPC F16M 11/00; H02J 7/35; F21L 4/00
USPC 362/154; 248/545; 320/101

(57) ABSTRACT

A mobile beach storage pole includes a cup holder attached to the upper section of the pole and a storage basket attached to the middle section of the pole. The cup holder may be formed to include a cavity for receiving ice or an insulator material to keep the beverage in the cup holder cold. The basket attached to the middle section of the pole is preferably rectangular in shape and may include a lid which may be lockable to secure personal items. The lower section of the pole is tapered to facilitate insertion of the pole into the ground. A solar battery is attached to the upper section of the pole and is used to power or charge a light or an electronic device. A hook is provided to provide additional storage capacity for items such as towels, apparel or other items.

### BACKGROUND OF THE INVENTION

1. Field of the Invention

The present invention relates generally to beach accessories, and more particularly, to a pole with a cup holder and other attachments to store and improve access to items while participating in recreational activities at a beach.

2. Description of the Related Art

In the recreational industry, chairs, lounges, umbrellas, canopies and cabanas have become commonplace, especially at beaches, outdoor concerts, festivals, sporting events, and other outdoor activities such as camping, tailgating, and picnics. During these activities, large quantities of beverages are typically consumed. It is often desirable to store these beverages at a low temperature while also allowing consumers of the beverages to have ready access to them. It is well known to provide a cooler or an ice chest for the storage of beverages. However, once removed from such containers, one typically holds a beverage in his hand until the beverage has been consumed. During the timeframe between removal of the beverage from a cooler, for example, and the complete consumption of the beverage, the temperature of the beverage may rise. This is especially problematic when the beverage is intended to be consumed while cold such as is the case with a soda or beer. Thus, holding a container containing a beverage which is intended to remain cold has several negative consequences including increasing the temperature of the beverage, making the hands of the person holding the beverage cold and uncomfortable, as well as unnecessarily occupying the hands of the person drinking the beverage.

Another challenge encountered while participating in recreational activities concerns the question of how to have convenient access to personal items while at the same time fully enjoying the particular activity involved. Often, keeping personal items on one's person such as in a pocket is simply not feasible. For example, it would not be practicable to keep electronic devices such as a cell phone in your pocket while swimming. At other times, keeping personal items on one's personal may adversely impact personal appearance or performance due to the added weight, unsightly bulk, or for other reasons. Such would be the case, for example, when presented with the challenge of storing a brush, sun tan lotion, a cell phone, and keys while wearing a swimsuit. Obviously many other concerns such as protection from theft or damage may dictate that personal items be stored while participating in recreational activities. Lockers are commonly used for this purpose. However, in many instances, locker rooms with personal lockers, when available, may be inconvenient to use because of their cost or remote location. Thus, there is a need for a means to conveniently store beverages and personal items such as smart phones, money, credit cards, eye glasses, medicine, cosmetics, keys, snacks, and the like while participating in recreational activities, especially while at a beach or at a swimming pool.

Several prior art attempts have been made to store a beverage while participating in recreational activities at a beach. For example, U.S. Pat. No. 6,732,985 discloses a beach utility pole with a cup holder and a bottom section which is tapered for easy insertion into sand or turf. In addition, U.S. Pat. No. 5,570,863 discloses a spiraled drink holder with a lower section which is pointed for easy insertion into the ground. While these prior art efforts allow one to store a beverage and have ready access to it for consumption, a drawback is that they do not address the need to keep the beverage cold. Another drawback is that these prior art efforts do not provide a means to store personal items such as smart phones, money, credit cards, eye glasses, medicine, cosmetics, keys, snacks, and the like. Thus, the need exists for an improved way to store and cool a beverage as well as conveniently store and secure personal effects while participating in recreational activities.

### BRIEF SUMMARY OF THE INVENTION

The present invention is directed to a storage pole that satisfies the need for an improved storage means for use while participating in recreational activities. A beach storage pole having features of the present invention comprises a pole, a cup holder and a storage basket. The cup holder is attached to an upper section of the pole while the storage basket is attached to a middle section of pole. The pole also has a lower section which is tapered to facilitate insertion of the pole into the ground.

In accordance with one aspect of the present invention, a cavity is formed in the cup holder to receive ice so as to keep the beverage in the cup holder cold. Alternatively, this cavity may be provided with an insulating material such as foam or neoprene.

In another embodiment of the present invention, a solar battery is provided for powering an electronic device such as a smart phone, PDA or the like. The solar battery is preferably attached to the upper section of the pole so as to provide a direct line of sight to sun rays, unobstructed by other items attached to the pole. The solar battery may also include an integral light such as an LED light or the solar battery may separately power a light which may be attached to the pole.

In yet another embodiment, a hook is attached to the pole so that a towel or an article of clothing such as a hat or beach wrap can be stored. The hook is preferably attached to the upper section of the pole so as to allow adequate ground clearance for items hanging on the hook.

In still another embodiment, the storage basket is provided with a lid which may include a locking mechanism to secure personal items in the storage basket.

It is therefore an object of the present invention to provide convenient place to store a beverage while participating in recreation activities.

It is another object of the present invention to provide a cup holder and storage device for personal items which is relatively inexpensive and easy to manufacture.

It is yet another object of the present invention to provide a cup holder which is capable of maintaining beverages stored therein at a relatively low temperature.

It is still another object of the present invention to provide a cup holder which protects beverages stored therein from spillage and from debris at ground level such as sand.

It is another object of the present invention to provide a means for illuminating the area in close proximity to the user of the present invention.

It is still another object of the present invention to provide a means for powering or charging personal electronic devices such as cell phones, PDAs and the like.

These and other aspects, advantages and novel features of the invention will become more apparent from the following detailed description of the invention when considered in conjunction with the accompanying drawings.

### BRIEF DESCRIPTION OF THE DRAWINGS

FIG. 1 is a perspective view of a mobile beach storage pole according to the present invention.

FIG. 2 is a perspective view of an alternative embodiment of the cup holder for the mobile beach storage pole of the present invention.

FIG. 3 is a perspective view of an alternative embodiment of the mobile beach storage pole of to the present invention.

### DETAILED DESCRIPTION OF THE INVENTION

For the purposes of promoting an understanding of the principles of the invention, reference will now be made to the embodiments illustrated in the drawings and specific language will be used to describe the same. It will nevertheless be understood that no limitation of the scope of the invention is thereby intended, such alterations and further modifications in the illustrated embodiments, and such further applications of the principles of the invention as illustrated therein being contemplated as would normally occur to one skilled in the art to which the invention pertains.

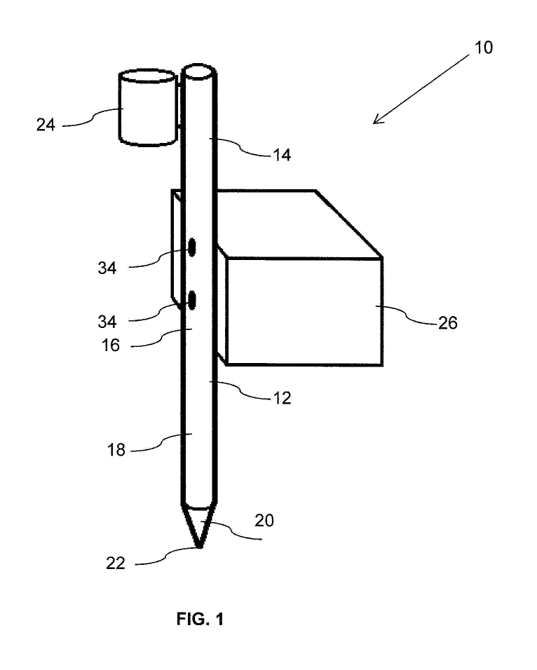

Referring to FIG. 1, the present invention is generally indicated at 10 and includes a unitary pole 12 having an upper section 14, a middle section 16, and a lower section 18. The pole 12 is preferably formed of a rigid plastic material although other suitable sturdy materials such as metal or wood may be used.

The upper section 14 is disposed towards the top of the pole whereas the lower section 18 is located distal from the upper section 14. The middle section 16 is positioned between the lower section 18 and the upper section 14 of the pole.

In the preferred embodiment of the present invention, the lower section 18 is located beneath the middle section 16 and has a tapered section 20 which terminates in a point 22 to facilitate the insertion of the pole 12 into the ground. The primary function of the lower section 18 is to provide support for the upper section 14 and middle section 16. Another key function of the lower section 18 is to provide a sturdy base for the pole 12 when the pole is inserted into the ground. The pole 12 should be inserted into the ground to a depth sufficient to allow the pole to remain sturdy and upright when in use.

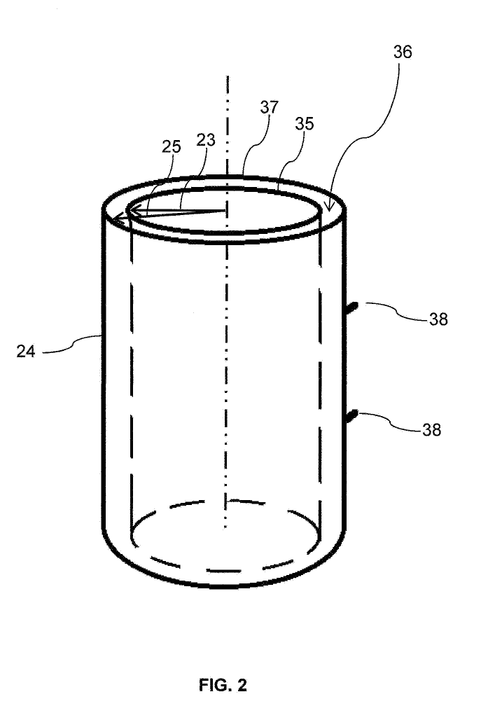

In the preferred embodiment of the present invention, the upper section 14 of the pole 12 has a cup holder 24 mounted thereon. The cup holder 24 is preferably cylindrical in shape to accommodate a wide variety of sizes and shapes of beverage containers such as plastic soda bottles, aluminum cans, and paper cups. As shown in FIG. 2, a cavity 36 may formed in the cup holder 24 to receive ice so as to keep the beverage in the cup holder cold. Alternatively, the cavity 36 may be provided with an insulating material such as foam or neoprene. The cavity 36 is defined by an outer shell 37 of the cup holder 24 and an inner shell 35 which has a radius 23 which is less than the radius 25 of the outer shell 37 of the cup holder 24. In the preferred embodiment, the cup holder 24 is formed as an integral part of mobile beach storage pole 12 of the present invention. Alternatively, the cup holder may be a separate, standalone item which may be affixed to the upper section of the pole by any suitable fastening means 38 such as gluing, nailing, snapping on, screwing or with a hook and loop fastening system, for example. It will be clear to those skilled in the art that the cup holder 24 of the present invention may be attached at any convenient point along the pole 12.

Referring again to FIG. 1, the middle section 16 includes a storage basket 26 mounted thereon. The storage basket 26 is preferably rectangular in shape and sized so as to accommodate a wide variety of personal items such as smart phones, money, credit cards, eye glasses, medicine, cosmetics, keys, snacks, fishing bate and the like. The storage basket 26 is preferable formed as an integral part of the mobile beach storage pole 12 of the present invention. Alternatively, the storage basket 26 may be a separate, standalone item which may be affixed to the middle section 16 of the pole by any suitable fastening means 34 such as those described above with respect to the cup holder 24. The storage basket may include a cover or lid (not shown) to protect items placed in the storage basket. A lock may also be provided to further protect and secure the items stored in the storage basket.

The pole 12 typically has an overall height between about twelve inches and forty-eight inches. When the pole 12 is about twelve inches long, a relatively small portion of the pole is available to be inserted into the ground while also providing the necessary ground clearance and support for the items affixed to the pole. A pole 12 which is about 12 inches in height might be suitable, for example, when the user of the pole 12 is reclining on a towel or blanket. When the pole 12 is about forty-eight inches in length, a relatively large portion of the pole is available to be exposed above ground. In this case, more of the pole 12 may be inserted into the ground or sand to provide the necessary ground clearance and support for the items affixed to the pole. For the convenience of a user of the pole 12 who is seated in chair such as a beach chair, for example, the height of the pole is preferably between about twenty-five inches and thirty-five inches. Most preferably, the pole 12 is about thirty inches long. As will be appreciated by those skilled in the art, pole 12 may be telescopic so that it's length may be adjusted to suit the needs of the user of the pole.

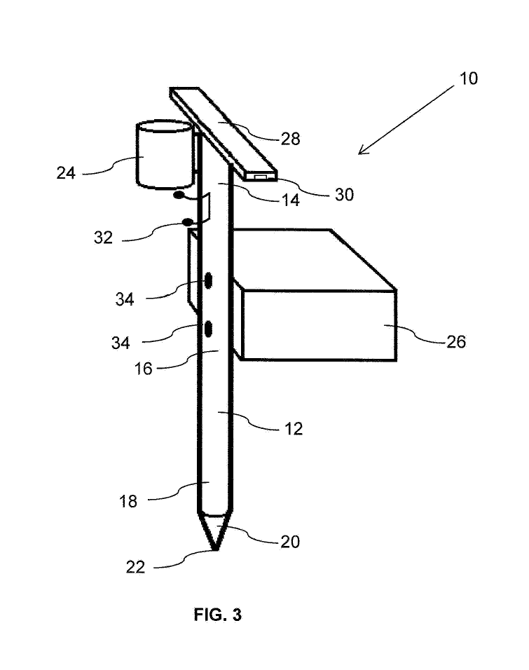

Referring now to FIG. 3, the mobile beach storage pole 12 of the present invention may also include a solar battery 28. The solar battery 28 harnesses sun rays via solar cells (not shown) and converts solar energy to electricity to power or charge an electronic device. As shown, the solar battery includes a USB port 30 which may be used to connect an electronic device via a charging cable. The solar battery 28 is preferably attached to the upper section 14 of the pole 12 so as to provide a direct line of sight to sun rays, unobstructed by other items attached to the pole 12. The solar battery 28 may also include an integral light such as an LED light or the solar battery 28 may separately power a light which may be attached to the pole 12.

The mobile beach storage pole 12 of the present invention may also be provided with a storage hook 32. The storage hook 32 is connected at any convenient point along pole and is used to store such items as towels, wet clothing, scarves, hats, and other items.

The pole and attachments thereto are preferably formed from injection molded plastic. However, it will be appreciated by those skilled in the art that different materials such as metal or wood may be used. The mobile beach storage pole 12 of the present invention is designed to be inexpensive to manufacture and consumer friendly because of its low cost, convenience and portability. Thus, from the embodiments described herein, a mobile beach storage pole 12 can be adapted to store a beverage container and personal effects allowing one to freely participate in recreation activities without the burden of having to carry around the beverage and personal items.

Although the invention has been described in terms of exemplary embodiments, it is not limited thereto. Rather, the appended claims should be construed broadly, to include other variants and embodiments of the invention, which may be made by those skilled in the art without departing from the scope and range of equivalents of the invention.

1. A mobile storage device, comprising:
a pole having an upper section, a lower section distal from said lower section, and a middle section positioned between said upper section and said lower section, said lower section being tapered to facilitate insertion of said pole into the ground;
a generally cylindrical cup holder attached to said pole at said upper section;
a storage basket attached to said pole at said middle section; and
a solar battery attached to said pole, said solar battery having a usb port whereby an electric device may be connected to said battery for powering and charging.

2. The mobile storage device of claim 1, wherein said cup holder comprises a cavity defined by an outer shell having a first radius and an inner shell having a second radius, said second radius being less than said first radius.

3. The mobile storage device of claim 2, further comprising a insulating material disposed in said cavity.

4. The mobile storage device of claim 1, wherein said storage basket is generally rectangular in shape.

5. The mobile storage device of claim 1, wherein said storage basket is provided with a cover to protect items stored in said storage basket.

6. The mobile storage device of claim 5, wherein said cover is provided with a lock to further protect items stored in said storage basket.

7. The mobile storage device of claim 1, wherein said pole has an overall height between about twelve inches and about forty-eight inches.

8. The mobile storage device of claim 7, wherein said pole has an overall height between about twenty-five inches and about thirty-five inches.

9. The mobile storage device of claim 8, wherein the overall height of said pole is about thirty inches.

10. The mobile storage device of claim 1, wherein said pole is telescopic whereby the overall height of the pole is adjustable.

11. (canceled)

12. (canceled)

13. The mobile storage device of claim 1, wherein said solar battery further comprises a source of light.

14. (canceled)

15. A mobile storage device, comprising:
a pole having an upper section, a lower section distal from said lower section, and a middle section positioned between said upper section and said lower section, said lower section being tapered to facilitate insertion of said pole into the ground;
a generally cylindrical cup holder attached to said pole at said upper section;
a storage basket attached to said pole at said middle section;
a solar battery attached to said pole , said solar battery having a USB port for charging an electrical device; and
a storage hook attached to said pole whereby items may be stored on said storage hook.

16. A mobile storage device, comprising:
a pole having an upper section, a lower section distal from said lower section, and a middle section positioned between said upper section and said lower section, said lower section being tapered to facilitate insertion of said pole into the ground;
a cup holder attached to said pole at said upper section; and
a solar battery having a usb port attached to said pole whereby an electric device may be connected to said battery for powering and charging; and
a usb port.

17. A mobile storage device, comprising:
a pole having an upper section, a lower section distal from said lower section, and a middle section positioned between said upper section and said lower section, said lower section being tapered to facilitate insertion of said pole into the ground
a storage basket attached to said pole at said middle section; and
a solar battery having a usb port attached to said pole whereby an electric device may be connected to said battery for powering and charging.
